(19) United States
(12) Patent Application Publication
(10) Pub. No.: US 2020/0328501 A1
(43) Pub. Date: Oct. 15, 2020

(54) MOBILE TERMINAL

(71) Applicant: LG ELECTRONICS INC., Seoul (KR)

(72) Inventors: Byungjin KANG, Seoul (KR); Sangku PARK, Seoul (KR); Songyi LEE, Seoul (KR); Jihwan KIM, Seoul (KR); Ansun HYUN, Seoul (KR); Chisang YOU, Seoul (KR)

(73) Assignee: LG ELECTRONICS INC., Seoul (KR)

(21) Appl. No.: 16/305,795

(22) PCT Filed: Jun. 24, 2016
(86) PCT No.: PCT/KR2016/006761

§ 371 Date: Nov. 29, 2018

(30) Foreign Application Priority Data
Jun. 1, 2016 (KR) 10-2016-0068186

(51) Int. Cl. H01Q 1/24; H01Q 5/328; H01Q 5/335; H04M 1/02; H01Q 9/30; H01Q 9/04; H04B 1/38

(52) U.S. Cl. CPC H01Q 1/243; H01Q 5/328; H01Q 5/335; H04B 1/38; H01Q 9/30; H01Q 9/045; H04M 1/026

(57) ABSTRACT

Provided is a mobile terminal comprising: a case; an antenna radiator mounted in the case; a ground mounted in the case; an radio frequency (RF) signal supply unit for generating a Radio Frequency (RF) signal; a feeding line connecting the RF signal supply unit and a first point of the antenna radiator so as to supply the RF signal; a switch having one end apart from the feeding line and selectively connecting one of a plurality of ports to the ground; a capacitor connected in parallel to the feeding line; a transmission line connecting the capacitor and a first port of the switch; and a first switch line connecting a second port of the switch and a second point of the antenna radiator, whereby the mounting area and the number of the switches can be reduced, and thus the manufacturing cost can be decreased and space efficiency can be improved.

### FIELD OF THE DISCLOSURE

Embodiments of the present disclosure relate to a mobile terminal including an antenna configured to transceive wireless communication.

### BACKGROUND OF THE DISCLOSURE

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

A conventional mobile communication system adopts a single antenna. However, with diversified functions of the antenna, there are many types of antennas and a plurality of antennas tends to be loaded for diverse wireless communication methods including short range wireless communication (e.g., satellite communication, WiFi, NFC and Bluetooth) and DMB as well as calls, LTE communication and 2G and 3G communication.

For LTE communication, every region or telecommunication company uses various frequency band signals. Even when using the same communication method, a resonance frequency has to be tuned according to every different frequency band. Rather than the number of the antennas according to the communication method, the space for loading the antennas has to be increased to satisfy such diverse frequency band signals for LTE disadvantageously.

### SUMMARY OF THE DISCLOSURE

### Technical Problem

Accordingly, an object of the present invention is to address the above-noted and other problems and provide a mobile terminal including an antenna of which a resonance frequency in a low band is not variable while a resonance frequency in a high band is tuned or the resonance frequency in the high band is not variable while the resonance frequency in the low band is tuned and which is able to move the resonance frequency in the low band when moving the high band resonance according to Carrier Aggregation (CA).

### Technical Solution

Embodiments of the present disclosure may provide a mobile terminal comprising a case; an antenna radiator loaded in the case; a ground mounted in the case; an RF signal supply unit configured to generate a Radio Frequency (RF) signal; a feeding line connected with a first point of the antenna radiator from the RF signal supply unit and configured to feed the RF signal; a switch spaced having one end apart from the feeding line and configured to selectively connect one of plural ports with the ground; a capacitor connected with the feeding line in parallel; a transmission line configured to connect the capacitor with a first port of the switch; and a first switch line configured to connect a second port of the switch with a second point of the antenna radiator.

The first point may be spaced apart from the first point of the antenna radiator.

The switch line may comprise a first matching circuit.

The transmission line may comprise a second matching circuit.

The second matching circuit may comprise a (an) inductor or capacitor.

The transmission line may be a signal line formed on a substrate, a flexible substrate or a coaxial cable.

The antenna radiator may comprise a metal case which forms a predetermined area of the case.

The antenna radiator may comprise a conductive pattern attached to the case.

The antenna radiator may be connected with the ground at a third point.

The ground may comprise a plate-shaped metal frame loaded in the case.

The plurality of the second ports may be provided, and one side of the first switch line may be connected with the second point and the other side is branched and connected with the plurality of the second ports.

The mobile terminal may further comprise a second switch line configured to connect a third port of the switch with a third point of the antenna radiator.

The antenna radiator may comprise a first antenna radiator comprising the first point; and a second antenna radiator comprising the second point.

A resonance frequency in a frequency band of 1 GHz or more that is transceived by the antenna radiator may be turned according to connection or disconnection between the switch and the first port, and a frequency band of 1 GHz or less may be not tuned.

Embodiments of the present invention may also provide a mobile terminal comprising a case; an antenna radiator loaded in the case; a ground mounted in the case; an RF signal supply unit configured to generate a Radio Frequency (RF) signal; a feeding line connected with a first point of the antenna radiator from the RF signal supply unit and configured to feed the RF signal; a switch spaced having one end apart from the feeding line and configured to selectively connect one of plural ports with the ground; a transmission line configured to connect a first point of the antenna radiator with a first port of the switch; and a first switch line configured to connect a second point of the antenna radiator with a second point of the antenna radiator.

### BACKGROUND OF THE DISCLOSURE

### Effects of the Invention

As mentioned above, the mobile terminal according to at least one of the embodiments may tune the resonance frequency in the high band by using the switch configured to tune the resonance frequency in the low band. Accordingly, the space required in mounting the switch and the number of the switches may be reduced and then the production cost may be saved. In addition, spatial occupancy may be enhanced.

Furthermore, the mobile terminal may tune no resonance frequency in the low band while tuning the resonance frequency in the high band. Accordingly, the resonance frequency may be turned only by adjusting the switch, instead of loading other design antennas to meet the frequency requirements for every telecommunication company and every country.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1A is a block diagram of a mobile terminal in accordance with the present disclosure.

FIGS. 1B and 1C are conceptual views of one example of the mobile terminal, viewed from different directions;

FIG. 2 is a graph to describe resonance frequency tuning of the mobile terminal;

FIG. 3 is a conceptual diagram illustrating an antenna of the mobile terminal in accordance with one embodiment;

FIG. 4 is a diagram specifically illustrating a circuit of FIG. 3;

FIG. 5 is a graph to describe variation of the resonance frequency according to ON/OFF of a switch provided in the mobile terminal; and

FIG. 6 is a conceptual diagram illustrating an antenna of the mobile terminal in accordance with another embodiment.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

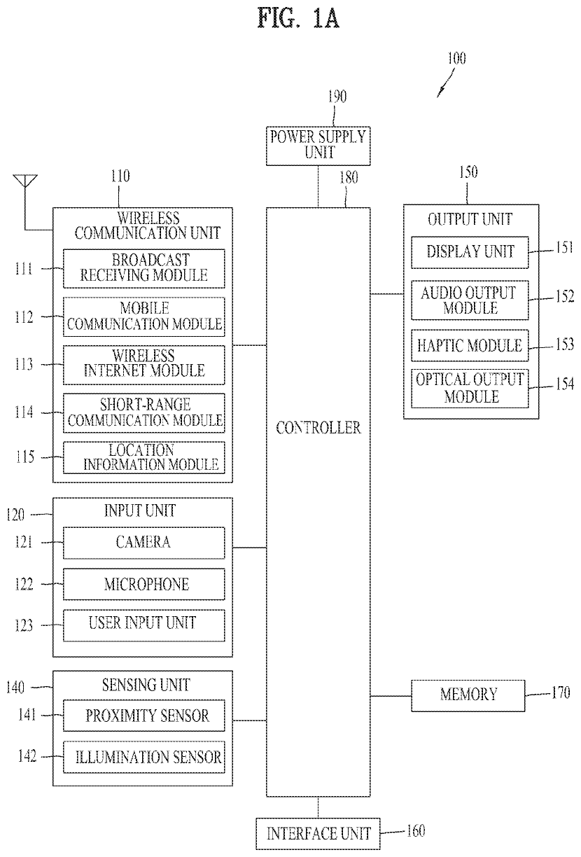

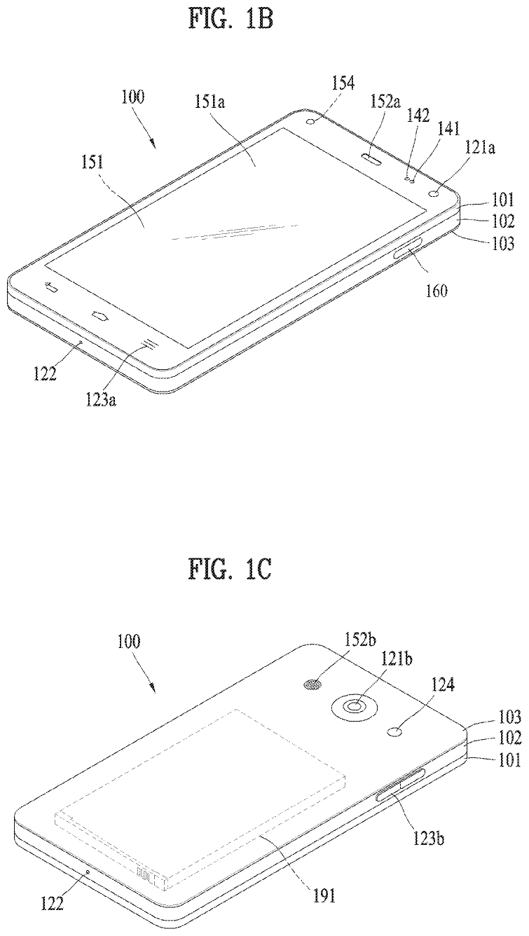

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in The FIG. 1A is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Hereinafter, referring to FIG. 1, the components mentioned above will be described in detail before describing the various embodiments which are realized by the mobile terminal 100 in accordance with the present disclosure.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sensing unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 may be provided with the power supplied by an external power source and the power supplied therein under the control of the controller 180 so as to supply the needed power to each of the components. The power supply unit 190 may include a battery. The battery may be a built-in type which is rechargeable and detachably loaded in the terminal to be charged.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal (100) to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the audio output module, the proximity sensor 141, the illuminance sensor 142, the optical output module 154, the camera 121, the user input unit 123, the microphone 122 and the interface unit 160.

It will be described for the mobile terminal as shown in FIGS. 1B and 1C. The display unit 151, the first audio output module 152a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 152b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The mobile communication module 112 may use diverse communication methods for mobile communication. However, the most popular communication method used for the mobile communication module 112 is Long Term Evolution (LTE). 4th Generation (4G) communication or Long Term Evolution (LTE) has developed to process the data growth exploded with increase of mobile terminal supply such as smart phones, tablet PC and the like. Such LTE is able to transmit data at a 100 Mbps˜1 Gbps such that it can transmit not only a voice and text message but also a video file in a short time fast enough to allow a user to view the video file in real time.

LTE is the follow-on to WCDMA which is 3th Generation (3G) communication and has an advantage of easy connection with a conventional 3G communication network. Due to such an advantage, LTE is able to reduce network investment costs and becomes an international communication standard.

The first LTE transmitted a signal at 75 Mbps, using a specific frequency at a bandwidth of 10 MHz. Examples of an advanced LTE technique having a transmission speed which is twice to four times faster than a transmission speed of the first LTE include Long Term Evolution-Advanced (LTE-A), broadband LTE, broadband LTE-A and 3-band LTE-A.

LTE-A is a technique which doubles the transmission speed by increasing the bandwidth from 10 MHz to 20 MHz. To double the frequency bandwidth, LTE-A adopts Carrier Aggregation. Such Carrier Aggregation is one of main LTE-A techniques and called ‘CA’ which aggregates and uses two frequencies at different bandwidths as one frequency. For instance, the transmission speed is doubled by a LTE service provided at a total bandwidth of 20 MHz using a 1.8 GHz frequency (a high frequency) at a 10 MHz bandwidth and an 800 MHz frequency (a low frequency) at a 10 MHz bandwidth to facilitate a transmission speed of 150 Mbps.

As increasing the frequency bandwidth to 20 MHz, in other words, doubling the frequency bandwidth, Broadband LTE is able to facilitate data transmission at 150 Mbps which is twice faster than the transmission speed of LTE. Different from LTE-A, Broadband LTE secures 20 MHz by adding frequency at a near band to a conventional frequency, not aggregating the signals at two frequency bands.

Broadband LTE-A increases a main frequency bandwidth (e.g., 1.8 GHz) such as Broadband LTE to 20 MHz and adds two different bandwidths of 10 MHz (e.g., 900 MHz) to the increased bandwidth of 20 MHz by using CA technique, so as to triple the transmission speed. In other words, Broadband LTE-A is able to transmit data at 225 Mbps.

3-band LTE-A is a technique configured to use three aggregated frequencies as one frequency and able to provide a data transmission service at the total bandwidth of 40 MHz after adding two different frequency bandwidths of 10 MHz to the broadband LTE bandwidth of 20 MHz. in other words, 3-band LTE-A is able to transmit data at 300 Mbps which is four times faster. Currently, all of Korean telecommunication companies are supporting the 3-band LTE-A service.

Every country uses a different telecommunication technique (e.g., LTE-A, Broadband LTE, Broadband LTE-A or 3-band LTE-A). Even if providing the 3-band LTE-A service which uses signals at three frequency bands including a low band, a mid-band and a high band, each of the telecommunication companies in every country use a different specific frequency range and a different product has to be manufactured for every telecommunication company disadvantageously.

As one example, companies in North America has used a frequency band B5 (82 MHz˜894 MHz)+B7 (2500 MHz˜2690 MHz) and they recently add B30 such as CA combination of B5 ((824 MHz˜894 MHz)+B30 (2305 MHz˜2360 MHz), B8 (880 MHz˜960 MHz)+B30 (2305 MHz˜2360 MHz). Accordingly, there is increasing demands for an antenna which is able to transceive a signal of B30 as well as a signal B7 which a conventional high-band antenna is able to transceive.

In case a resonance frequency needs to be tuned, a method is typically used that a configuration of a circuit connected with an antenna radiator is changed. In other words, the configuration of the circuit is variable by using a switch 230 or a connection type of plural antenna radiators is variable by using a switch 230 so as to vary the resonance length or shape of the antenna radiator.

The variation range of the resonance frequency is not so wide that it may be difficult to change a resonance frequency in a broadband from a low band of 1000 MHz or less into a mid-band of 1700 MHz˜2200 MHz or a high band of 2300 MHz or more. Accordingly, the resonance frequency is tuned in the low band, the mid-band or the high band. At this time, it is important not to change a resonance frequency in the other bands.

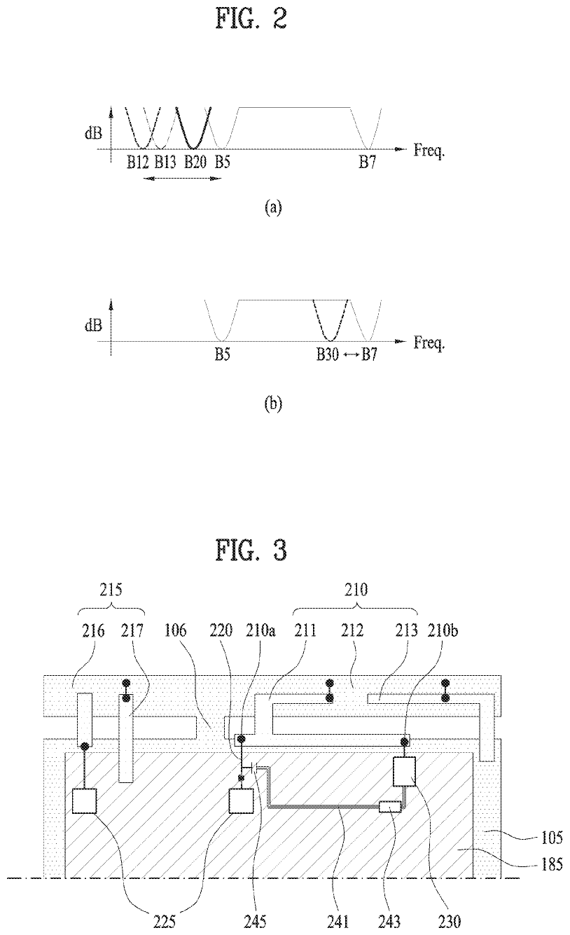

FIG. 2 is a graph to describe resonance frequency tuning of the mobile terminal and showing S-parameter. A horizontal axis of the graph refers to a frequency and a vertical axis refers to S11 (dB). As showing a larger negative value, a transmission performance is more excellent. FIG. 2 shows a graph in which a value of S11 is noticeably projected downwards at a frequency corresponding to a resonance frequency.

When changing a resonance frequency (B12, B13, B20 and B5) in a low band as shown in FIG. 2 (a), a resonance frequency (B7) in a high band has to be unchanged. When changing a resonance frequency (B7 and B30) as shown in FIG. 2 (b), the resonance frequency in the low band has to unchanged.

A new design of an antenna having an antenna radiator provided for every frequency band but one antenna radiator used to transceive the plural frequency band signals, when using the signal in the plural frequency bands, has developed and a narrow space of the mobile terminal may be utilized efficiently.

When one resonance frequency in one of the low and high bands is tuned in case of using an antenna radiator for the low band and another antenna radiator for the high band, a resonance frequency in the other band is not changed drastically. However, when the resonance frequency is tuned in one band in case of transceiving all of the signals in the low band and the high band by using one antenna radiator as mentioned above, the resonance frequency in the other band is also turned disadvantageously.

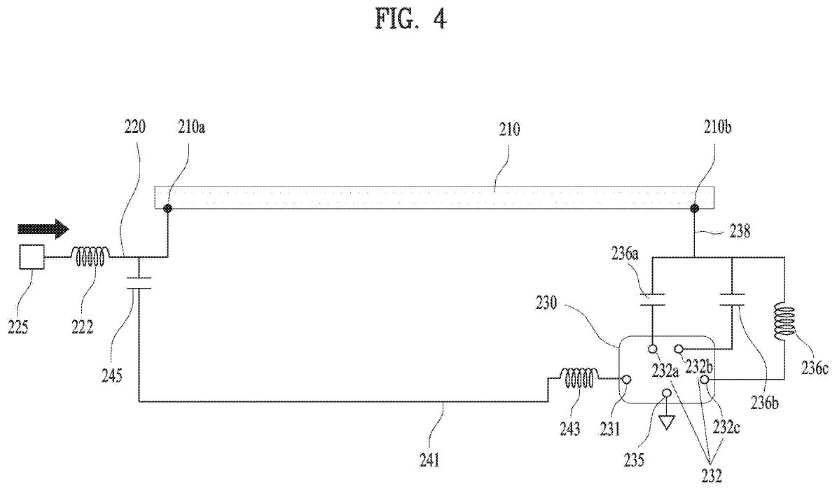

FIG. 3 is a conceptual diagram illustrating an antenna of the mobile terminal in accordance with one embodiment and FIG. 4 is a diagram specifically illustrating a circuit of FIG. 3. In FIGS. 3 and 4 are shown an antenna radiator 210, an RF signal supply unit 225, a feeding line 220, a switch 230, a transmission line 241, a matching element 243 and 236, a capacitor 245, a middle frame 105 and a substrate 185.

The middle frame 105 is provided on a rear surface of the display unit 151 of the mobile terminal 100 and configured to support the display unit 151 and maintain the strength of the slim and thin mobile terminal 100 simultaneously. If the middle frame 105 is made of metal for the strength of the mobile terminal 100, the middle frame 105 may be used as a ground, using conductivity of metal. The ground is not limited to the middle frame and a metal case or other metal components may be used as the ground.

The substrate 185 may have diverse ICs loaded thereon or a circuit realized thereon to control the components. In addition, the substrate 185 may be connected with the power supply unit 190 and the ground 105 to serve as an intermediary for the power supply and grounding of the various electronic components. The substrate 185 may be overlapped with the middle frame 105 in a direction along the thickness. The feeding line 220 configured to transmit an RF signal to the antenna radiator 210, the switch 230 configured to connect with the ground 105 and the switch line 238 may be formed on the substrate 185.

The feeding line 220 for connecting with the RF signal supply unit 225 may be connected with a first point 210a of the antenna radiator 210 and the switch line 238 for connecting with the switch 230 may be connected with a second point 210b. The feeding line 220 may further include an inductor 222 or capacitor that is connected in serial for frequency matching.

The antenna radiator 210 may be spaced a preset distance apart from the middle frame 105 and form a predetermined area (a metal case 212) of the case provided in the mobile terminal 100. Also, the antenna radiator 210 may be formed in the case of the mobile terminal 100 as a pattern 211 and 213.

The antenna radiator 212 using some area of the case may serve as the case and the antenna radiator simultaneously such that one member may perform plural functions advantageously. If an outer metal case is arranged, the antenna performance could deteriorate. However, when the outer metal case is used as the antenna radiator, the antenna performance may be enhanced.

The antenna radiator 211 and 213 formed in the pattern type has advantages of the free arrangement and free length adjustment. However, the antenna radiator using the metal case has a disadvantage of deteriorated antenna performance. When using one pattern type antenna radiator, the internal space of the mobile terminal 100 is narrow and it is then difficult to realize the antenna radiator 210 which is able to secure a desired frequency band performance. Accordingly, diverse pattern types of conductors 211, 212 and 213 connected with each other may be used as the antenna radiator 210 to secure the antenna performance in a desired frequency band.

FIG. 3 illustrates one embodiment that a pattern type antenna radiator (or conductors 211 and 213 that are formed as a flexible substrate) and an antenna radiator 212 using a case are connected with each other to serve as one radiator 210. However, the present invention is not limited thereto. The antenna radiator 210 may be connected with the middle frame 105 via a connection area 106 and then connected with the ground.

In the embodiment shown in FIG. 3, the antenna radiator 210 located in a right side may transceive signals in both the high and low bands and the antenna radiator 215 located in a left side may transceiver signals in the mid band.

The present invention is not limited thereto. Alternatively, one radiator 210 may transceive signals in the mid and low bands or signals in the mid and high bands and another antenna radiator may transceive signals in the high band. Hereinafter, for simple description sake, the present invention adopts the embodiment that one antenna radiator 210 radiates signals in the high and low bands.

The low band (1000 MHz or less) and the high band (2300 MHz or more) are distant from each other. Even when one antenna radiator 210 is used, the low band and the high band are affected little. In this instance, even the resonance frequency of the high band (or the low band) might be changed disadvantageously when the antenna structure is changed or a matching circuit 232 and 243 is changed to tune the resonance of the low band (or the high band).

The wavelength of the low band is long and the wavelength of the high band is short. Accordingly, a switch 230 connected with a second point 210b spaced apart from the feeding line 220 configured to transmit an RF signal from the RF signal supply unit 225 may be provided as shown in FIG. 3 so as to change the circuit connected with the antenna radiator 210. Even when first matching circuits 236a, 236b and 236d selectively connected via the switch 230 are converted after the switch 230 is connected with the second point 210b spaced apart from the feeding line 220, the resonance frequency of the low band may be changed without shaking the resonance of the high band.

At this time, the switch 230 is not a 2-port switch 230 configured to simply switch ON/OFF but a multi-port-switch 230 having a plurality of ports and configured to connect the ground 105 with each of the ports. Each of the ports may be connected with each different one of the first matching circuits and the resonance frequency of the low band is turned according to the port connected with the switch 230 as shown in FIG. 2 (a). The switch 230 spaced apart from the second point 210b might have a deteriorated performance and variation. Accordingly, the switch 230 may be arranged as close to the second point 210b as possible.

The mobile terminal of the present invention may require a structure configured to convert the high band resonance frequency and maintain the low band resonance frequency at this time, rather than simply change the low band resonance frequency. To tune the high band resonance frequency, different from the low band resonance frequency, a capacitor 245 configured to tune the high band frequency may be provided near the feeding line 220.

The high band signal may be turned by changing an impotence of the circuit configured of the antenna radiator 210, the ground line, the switch line 238, the switch 230 and the ground 105. One side of the capacitor 245 is connected with the feeding line 220 and the other side is connected with the ground 104. As shown in FIG. 4, the capacitor 245 is connected with the antenna radiator 210 in parallel and the capacitor 245 has a following impotence value when connected in parallel.

Shunt_C(Z_{c})=1/jwC

In other words, the impotence value is proportional to a reciprocal number of the frequency. Accordingly, the impotence value becomes large when a low frequency signal flows, compared with a high frequency signal. The flowing frequency lowers a denominator of the above-noted formula and the impotence of the capacitor 245 connected in parallel becomes large. When the impotence is large, currents will not flow and there is no difference from a state where the circuit is open. Accordingly, the capacitor 245 may not greatly affect the low band signal.

The switch 230 has to be provided to selectively connect the capacitor 245 and the ground 105 with each other. If an additional switch 230 is provided, the space for mounting the additional switch 230 has to be secured and the additional switch 230 results in the additional cost disadvantageously.

As shown in FIG. 4, the capacitor 245 is connected with the ground line and the ground line is connected with the first point 210a of the antenna radiator 210. The switch 230 is arranged near the second point 210b of the antenna radiator 210. Accordingly, the capacitor 245 and the switch 230 are spaced apart from each other and a transmission line 241 has to be provided to connect the capacitor 245 and the switch 230 with each other. The transmission line 241 may be realized as a circuit on the substrate 185 or a coaxial cable or flexible substrate.

The impotence may be variable according to the length of the transmission line 241. To tune the resonance frequency into a desired frequency, the length of the transmission line 241 may be adjusted. However, as the transmission line 241 is provided to connect the switch 320 and the ground line which are spaced apart from each other, the length of the transmission line 241 has to be a predetermined value or more and the length may be increased to minimize the variation of the other component arrangement. When it is limited to adjust the length of the transmission line 241, a second matching circuit 243 may be provided on the transmission line 241 to gain the desired resonance frequency. The second matching circuit 243 may include an inductor as shown in FIG. 4.

Referring to FIG. 4, the switch 230 may include an RF common port 235 (RFC) connected with the ground 105; a first port 231 connected with the transmission line 241; and a second port 232 configured to be connected with a switch line 238 connected with the second point 210b of the antenna radiator 210.

As shown in FIG. 4, a plurality of second ports may be provided. The second ports 232a, 232b and 232c may be connected with the first matching circuits 236a, 236b and 236c, respectively. Each of the second ports 232a, 232b and 232c may be connected with the antenna radiator 210 at a different position or the same position as shown in FIG. 4. In other words, one side of the switch line 238 may be connected with the second point 210b and the other side may be connected with each of the second ports 232a, 232b and 232c.

Although not shown in the drawings, the switch line 238 connected with each of the second ports 232 may be connected with another antenna radiator 210 when the plurality of the antenna radiators 210 is provided.

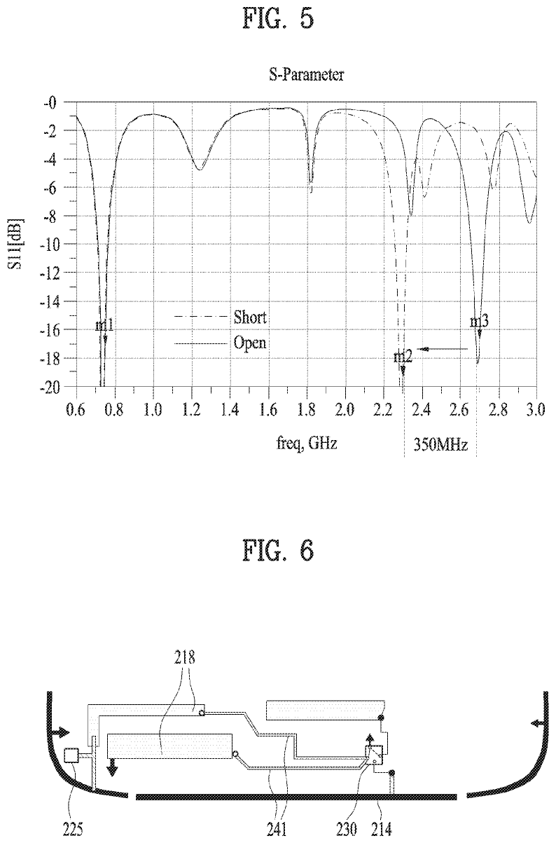

FIG. 5 is a graph to describe variation of the resonance frequency according to ON/OFF of the switch 230 provided in the mobile terminal. It is shown that the resonance frequency is moved in the high band farther by approximately 350 MH (m3>m2) when the first port 231 and the RFC port 235 are connected with each other than unless they are connected. The moving direction and distance of the resonance frequency may be adjusted by adjusting the lengths of the second matching circuit 243 and the transmission line 241 as mentioned above. At this time, the resonance frequency (m1) in the low band is little changed.

FIG. 6 is a conceptual diagram illustrating an antenna of the mobile terminal in accordance with another embodiment. Referring to FIG. 6, the low band radiator 214 configured to actuate in the low band is separated from the high band radiator 218 configured to actuate in the high band. In this instance, when switch 230 configured to change the first matching circuit connected with the low band radiator 214 to tune the low band resonance frequency is connected with the second matching circuit configured to tune the resonance frequency of the high band radiator 218, the plurality of the frequency band resonance frequencies may be turned by using one switch 230.

As the switch 230 is arranged adjacent to the low band radiator 214, the transmission line 241 connected with the high band radiator 218 is required and the high band resonance frequency may be tuned by using the transmission line 241 and the second matching circuit.

As mentioned above, the mobile terminal according to at least one of the embodiments may tune the resonance frequency in the high band by using the switch 230 configured to tune the resonance frequency in the low band. Accordingly, the space required in mounting the switch 230 and the number of the switches 230 may be reduced and then the production cost may be saved. In addition, spatial occupancy may be enhanced.

Furthermore, the mobile terminal may tune no resonance frequency in the low band while tuning the resonance frequency in the high band. Accordingly, the resonance frequency may be turned only by adjusting the switch 230, instead of loading other design antennas to meet the frequency requirements for every telecommunication company and every country.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A mobile terminal comprising:
a case;
an antenna radiator loaded in the case;
a ground mounted in the case;
an RF signal supply unit configured to generate a Radio Frequency (RF) signal;
a feeding line connected with a first point of the antenna radiator from the RF signal supply unit and configured to feed the RF signal;
a switch spaced having one end apart from the feeding line and configured to selectively connect one of plural ports with the ground;
a capacitor connected with the feeding line in parallel;
a transmission line configured to connect the capacitor with a first port of the switch; and
a first switch line configured to connect a second port of the switch with a second point of the antenna radiator.

2. The mobile terminal of claim 1, wherein the first point is spaced apart from the first point of the antenna radiator.

3. The mobile terminal of claim 1, wherein the switch line comprises a first matching circuit.

4. The mobile terminal of claim 3, wherein the transmission line comprises a second matching circuit.

5. The mobile terminal of claim 4, wherein the second matching circuit comprises a (an) inductor or capacitor.

6. The mobile terminal of claim 1, wherein the transmission line is a signal line formed on a substrate, a flexible substrate or a coaxial cable.

7. The mobile terminal of claim 1, wherein the antenna radiator comprises a metal case which forms a predetermined area of the case.

8. The mobile terminal of claim 1, wherein the antenna radiator comprises a conductive pattern attached to the case.

9. The mobile terminal of claim 1, wherein the antenna radiator is connected with the ground at a third point.

10. The mobile terminal of claim 1, wherein the ground comprises a plate-shaped metal frame loaded in the case.

11. The mobile terminal of claim 1, wherein the plurality of the second ports is provided, and
one side of the first switch line is connected with the second point and the other side is branched and connected with the plurality of the second ports.

12. The mobile terminal of claim 1, further comprising:
a second switch line configured to connect a third port of the switch with a third point of the antenna radiator.

13. The mobile terminal of claim 1, wherein the antenna radiator comprises,
a first antenna radiator comprising the first point; and
a second antenna radiator comprising the second point.

14. The mobile terminal of claim 1, wherein a resonance frequency in a frequency band of 1 GHz or more that is transceived by the antenna radiator is turned according to connection or disconnection between the switch and the first port, and
a frequency band of 1 GHz or less is not tuned.

15. A mobile terminal comprising:
a case;
an antenna radiator loaded in the case;
a ground mounted in the case;
an RF signal supply unit configured to generate a Radio Frequency (RF) signal;
a feeding line connected with a first point of the antenna radiator from the RF signal supply unit and configured to feed the RF signal;
a switch spaced having one end apart from the feeding line and configured to selectively connect one of plural ports with the ground;
a transmission line configured to connect a first point of the antenna radiator with a first port of the switch; and
a first switch line configured to connect a second point of the antenna radiator with a second point of the antenna radiator.
